(19) United States
(12) Patent Application Publication
(10) Pub. No.: US 2025/0351796 A1
(43) Pub. Date: Nov. 20, 2025

(54) CROP-LIVESTOCK CIRCULATION SYSTEM

(71) Applicant: Pingdingshan University, Pingdingshan (CN)

(72) Inventors: Xiaofei HAN, Pingdingshan (CN); Fang HUANG, Pingdingshan (CN); Di LU, Pingdingshan (CN); Xiaoran LI, Pingdingshan (CN); Junwei WANG, Pingdingshan (CN); Chenrui YANG, Pingdingshan (CN)

(21) Appl. No.: 19/287,758

(22) Filed: Jul. 31, 2025

Related U.S. Application Data
(63) Continuation of application No. PCT/CN2025/100038, filed on Jun. 10, 2025.

(30) Foreign Application Priority Data
Oct. 24, 2024 (CN) 202411488654.3

(51) Int. Cl. A01K 1/01; A01C 3/00; A01G 9/24; A01K 1/00; A01K 63/04; C02F 1/00; C02F 3/30; C02F 103/20; C05F 3/06; C05F 7/00; C05F 17/50; C05F 17/957

(52) U.S. Cl. CPC A01K 1/01; A01C 3/00; A01G 9/247; A01G 9/249; A01K 1/0052; A01K 63/045; C02F 1/001; C02F 3/30; C05F 3/06; C05F 7/00; C05F 17/50; C05F 17/957; C02F 2103/20

(57) ABSTRACT

A crop-livestock circulation system, including a planting greenhouse, a fish pond and a livestock greenhouse. A rear portion of the livestock greenhouse is provided with a drinking trough. A first side of the livestock greenhouse is provided with a scraper. A portion of a bottom plate close to a second side of the livestock greenhouse is provided with a collection port. A bottom of the collection port is provided with a manure collection trough connected to a fermentation treatment chamber. The fish pond is provided with a sewage discharge port connected to a sewage collection unit. The sewage collection unit is connected to the fermentation treatment chamber. The fermentation treatment chamber is connected to a conveying unit, which is connected to a spraying device. The spraying device is provided in the planting greenhouse.

### CROSS-REFERENCE TO RELATED APPLICATIONS

This application is a continuation of International Patent Application No. PCT/CN2025/100038, filed on Jun. 10, 2025, which claims the benefit of priority from Chinese Patent Application No. 202411488654.3, filed on Oct. 24, 2024. The content of the aforementioned application, including any intervening amendments thereto, is incorporated herein by reference in its entirety.

### TECHNICAL FIELD

This application relates to agricultural ecological technologies, and more particularly to a crop-livestock circulation system.

### BACKGROUND

Crop-livestock circulation is an important approach to promoting the green agricultural development. Green crop-livestock circulation refers to the effective integration of crop production and livestock farming, in which the livestock manure is collected and applied as a fertilizer to the soil to maximize the resource utilization, so as to promote the crop-livestock integration and ecological circulation. China has now entered a new phase of low-carbon agriculture, and how to recycle and apply the livestock manure to the crop production is critical.

Traditionally, the crop farming and the livestock breeding are relatively independent, and it fails to achieve the resource circulation therebetween. Fertilization in crop fields primarily relies on chemical fertilizers, which will often lead to soil compaction and acidification, resulting in nutrient imbalances and a decline in the crop yield and quality. Moreover, the use of chemical fertilizers not only fails to achieve the energy conservation and emission reduction, but also poses risks to human health and environment. In addition, the manure waste produced from the livestock and poultry farming will also cause environmental pollution.

Therefore, there is an urgent need to provide a crop-livestock circulation system to address the above-mentioned problems.

### SUMMARY

An object of the disclosure is to provide a crop-livestock circulation system to address the problem that traditional crop production and livestock farming systems are relatively independent, and it fails to achieve the resource circulation therebetween.

Technical solutions of the present disclosure are described as follows.

A crop-livestock circulation system, comprising:
a planting greenhouse;
a fish pond;
a fermentation treatment chamber;
a sewage collection unit;
a conveying unit;
a spraying device; and
a livestock greenhouse;
wherein a rear portion of the livestock greenhouse is provided with a drinking trough; the livestock greenhouse comprises a bottom plate; a first side of the livestock greenhouse is provided with a scraper; a portion of the bottom plate close to a second side of the livestock greenhouse is provided with a collection port, wherein the second side of the livestock greenhouse is opposite to the first side of the livestock greenhouse;
a bottom of the collection port is provided with a manure collection trough; and the manure collection trough is connected to the fermentation treatment chamber;
a sewage discharge port of the fish pond is connected to the sewage collection unit; and the sewage collection unit is connected to the fermentation treatment chamber; and
the fermentation treatment chamber is connected to the conveying unit; the conveying unit is connected to the spraying device; and the spraying device is provided in the planting greenhouse.

In some embodiments, an inner side of a top of the livestock greenhouse is provided with a lamp; and a side wall of the livestock greenhouse is provided with a ventilation fan.

In some embodiments, a front side of the scraper is fixedly provided with a plurality of nozzles arranged spaced apart; and the plurality of nozzles and the drinking trough are connected to a water source via a water pipe.

In some embodiments, the fermentation treatment chamber comprises an aerobic treatment unit and an anaerobic fermentation tank connected in sequence;
the aerobic treatment unit is connected to the sewage collection unit and the manure collection trough;
the anaerobic fermentation tank is connected to a fertilizer storage tank; and
the fertilizer storage tank is connected to the conveying unit.

In some embodiments, a bottom of the anaerobic fermentation tank is provided with a heating device.

In some embodiments, the conveying unit comprises a transport pipe and a self-priming centrifugal jet pump mounted on the transport pipe;
a first end of the transport pipe is connected to the fertilizer storage tank, and a second end of the transport pipe is connected to the spraying device; and
the transport pipe is provided with a stop valve.

In some embodiments, the spraying device comprises two slide rails and a transverse frame; the two slide rails are provided on two inner sides of the planting greenhouse, respectively; and the transverse frame is slidably provided between the two slide rails;
the transverse frame is provided with a water spray pipe; and
a plurality of nozzles are arranged evenly spaced apart on the water spray pipe.

In some embodiments, the water spray pipe is communicated with a first end of a water filter pipe;
a second end of the water filter pipe has two branches, and the two branches are communicated with to a water source and the transport pipe, respectively;
a filter screen is provided inside the first end of the water filter pipe;
the water filter pipe is connected to an underground pipe; and
the underground pipe is located on the water filter pipe at a side of the filter screen away from the water spray pipe.

Compared to the prior art, the present disclosure has the following beneficial effects.

The crop-livestock circulation system provided herein processes sediment from the fish pond together with poultry manure from the livestock greenhouse through aerobic treatment and anaerobic fermentation to produce organic fertilizer. The resulting fertilizer is applied to crops grown in the planting greenhouse. This system not only achieves the resource utilization of fish and livestock waste, but also avoids significant impact on the soil pH, thereby maintaining the quality of harvested fruits and vegetables.

### BRIEF DESCRIPTION OF THE DRAWINGS

In order to illustrate the technical solutions in the embodiments of the present disclosure or the prior art more clearly, the accompanying drawings needed in the description of the embodiments or prior art will be briefly described below. Obviously, presented in the accompanying drawings are only some embodiments of the present disclosure, and for those of ordinary skill in the art, other accompanying drawings can be obtained from the structures illustrated therein without making creative effort.

FIG. 1 is a structural diagram of a crop-livestock circulation system according to an embodiment of the present disclosure;

FIG. 2 is a structural diagram of a livestock greenhouse according to an embodiment of the present disclosure; and

FIG. 3 is a structural diagram of a planting greenhouse according to an embodiment of the present disclosure.

In the figures: 1—planting greenhouse; 2—fish pond; 3—livestock greenhouse; 4—drinking trough; 5—scraper; 6—collection port; 7—manure collection trough; 8—first nozzle; 9—sewage collection unit; 10—aerobic treatment unit; 11—anaerobic fermentation tank; 12—fertilizer storage tank; 13—transport pipe; 14—self-priming centrifugal jet pump; 15—stop valve; 16—spraying device; 17—slide rail; 18—transverse frame; 19—water spray pipe; 20—second nozzle; and 21—underground pipe.

### DETAILED DESCRIPTION OF EMBODIMENTS

The technical solutions in the embodiments of the present disclosure will be described clearly and completely below in conjunction with the accompanying drawings. It is obvious that the described embodiments are merely some embodiments of the present disclosure, instead of all embodiments. Based on the embodiments in the present disclosure, all other embodiments obtained by those of ordinary skill in the art without making creative effort shall fall within the scope of the present disclosure defined by the appended claims.

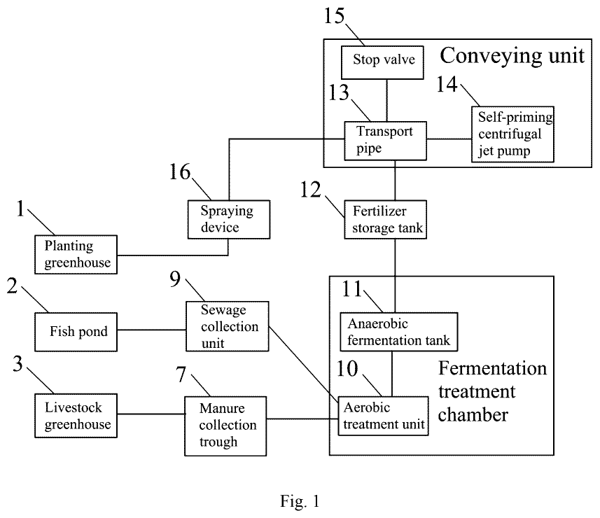

Referring to FIG. 1, an embodiment of the present disclosure provides a crop-livestock circulation system, including a planting greenhouse 1, a fish pond 2, a fermentation treatment chamber, a sewage collection unit 9, a conveying unit, a spraying device 16 and a livestock greenhouse 3.

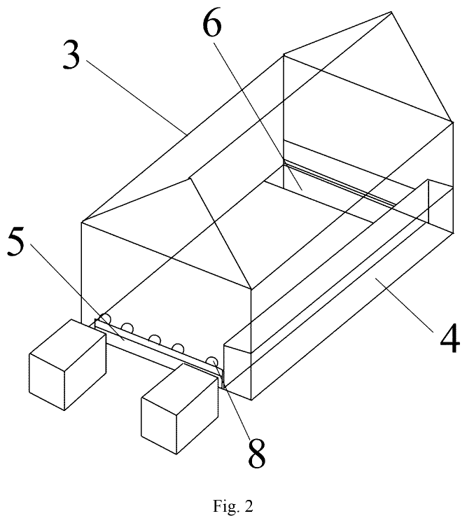

FIG. 2 is a structural diagram of the livestock greenhouse 3. A rear portion of the livestock greenhouse 3 is provided with a drinking trough 4. A right side of the livestock greenhouse 3 is provided with a scraper 5. A front side of the scraper 5 is fixedly provided with a plurality of first nozzles 8 arranged spaced apart. The plurality of first nozzles 8 and the drinking trough 4 are connected to a water source via a water pipe. The livestock greenhouse 3 includes a bottom plate. A portion of the bottom plate close to a left side of the livestock greenhouse 3 is provided with a collection port 6. The collection port 6 is generally covered by a removable baffle. The baffle is configured to open to expose the collection port 6 to collect manure. A rear side of the scraper 5 is provided with a motor. The motor is configured to drive the scraper 5 to move back and forth, thereby scraping waste and manure in the livestock greenhouse 3 toward the collection port 6. In addition, an inner side of a top of the livestock greenhouse 3 is provided with a lamp for illumination. A side wall of the livestock greenhouse 3 is provided with a ventilation fan for ventilation.

A bottom of the collection port 6 is provided with a manure collection trough 7. The manure collection trough 7 is connected to the fermentation treatment chamber. A sewage discharge port of the fish pond 2 is connected to the sewage collection unit 9. The sewage collection unit 9 is connected to the fermentation treatment chamber.

In this embodiment, the fermentation treatment chamber includes an aerobic treatment unit 10 and an anaerobic fermentation tank 11 connected in sequence. The aerobic treatment unit 10 is connected to the sewage collection unit 9 and the manure collection trough 7. The anaerobic fermentation tank 11 is connected to a fertilizer storage tank 12. A bottom of the anaerobic fermentation tank 11 is provided with a heating device.

The fertilizer storage tank 12 is connected to the conveying unit. In this embodiment, the conveying unit includes a transport pipe 13 and a self-priming centrifugal jet pump 14 mounted on the transport pipe 13. A first end of the transport pipe 13 is connected to the fertilizer storage tank 12, and a second end of the transport pipe 13 is connected to the spraying device 16. The transport pipe 13 is provided with a stop valve 15. The spraying device 16 is provided in the planting greenhouse 1.

In this embodiment, the spraying device includes two slide rails 17 and a transverse frame 18. The two slide rails 17 are arranged on two inner sides of the planting greenhouse 1, respectively. The transverse frame 18 is slidably provided between the two slide rails 17. The transverse frame 18 is provided with a water spray pipe 19. A plurality of second nozzles 20 are arranged evenly spaced apart on the water spray pipe 19.

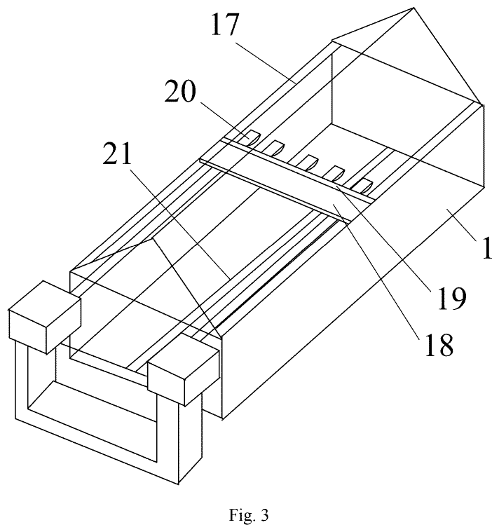

The water spray pipe 19 is communicated with a first end of a water filter pipe. A second end of the water filter pipe has two branches, and the two branches are communicated with a water source and the transport pipe 13, respectively. A filter screen is provided inside the first end of the water filter pipe. The water filter pipe is connected to an underground pipe 21. The underground pipe 21 is located on the water filter pipe at a side of the filter screen away from the water spray pipe 19. An end of the underground pipe 21 away from the water filter pipe is transversely embedded in the planting greenhouse 1 for irrigating plants. FIG. 3 is a structural diagram of the planting greenhouse 1.

Regarding the crop-livestock circulation system provided herein, manure within the livestock greenhouse is forced by the scraper to move into the manure collection trough and subsequently transferred to the aerobic treatment unit. Meanwhile, the sediment from the fish pond is discharged into the aerobic treatment unit via the sewage collection unit. After the aerobic treatment, the materials are transferred to the anaerobic fermentation tank for anaerobic fermentation. After processed, the resultant fertilizer is stored in the fertilizer storage tank. When crops in the planting greenhouse require the nutrient irrigation, the self-priming centrifugal jet pump installed on the transport pipe is activated to convey the fertilizer from the fertilizer storage tank to the spraying device. The fertilizer is then sprayed downward into the planting greenhouse through the second nozzles, or delivered through the underground pipe to irrigate the crops.

Described above are merely preferred embodiments of the present disclosure, and are not intended to limit the scope of the present disclosure. Any equivalent structural changes made based on the description and the accompanying drawings of the present disclosure under the inventive concept of the present disclosure, or direct/indirect application in other related technical fields shall fall within the scope of the present disclosure defined by the appended claims.

What is claimed is:

1. A crop-livestock circulation system, comprising:
a planting greenhouse;
a fish pond;
a fermentation treatment chamber;
a sewage collection unit;
a conveying unit;
a spraying device; and
a livestock greenhouse;
wherein a rear portion of the livestock greenhouse is provided with a drinking trough; the livestock greenhouse comprises a bottom plate; a first side of the livestock greenhouse is provided with a scraper; a portion of the bottom plate close to a second side of the livestock greenhouse is provided with a collection port, wherein the second side of the livestock greenhouse is opposite to the first side of the livestock greenhouse;
a bottom of the collection port is provided with a manure collection trough; and the manure collection trough is connected to the fermentation treatment chamber;
a sewage discharge port of the fish pond is connected to the sewage collection unit; and the sewage collection unit is connected to the fermentation treatment chamber; and
the fermentation treatment chamber is connected to the conveying unit; the conveying unit is connected to the spraying device; and the spraying device is provided in the planting greenhouse.

2. The crop-livestock circulation system according to claim 1, wherein an inner side of a top of the livestock greenhouse is provided with a lamp; and a side wall of the livestock greenhouse is provided with a ventilation fan.

3. The crop-livestock circulation system according to claim 2, wherein a front side of the scraper is fixedly provided with a plurality of nozzles arranged spaced apart; and the plurality of nozzles and the drinking trough are connected to a water source via a water pipe.

4. The crop-livestock circulation system according to claim 1, wherein the fermentation treatment chamber comprises an aerobic treatment unit and an anaerobic fermentation tank connected in sequence;
the aerobic treatment unit is connected to the sewage collection unit and the manure collection trough;
the anaerobic fermentation tank is connected to a fertilizer storage tank; and
the fertilizer storage tank is connected to the conveying unit.

5. The crop-livestock circulation system according to claim 4, wherein a bottom of the anaerobic fermentation tank is provided with a heating device.

6. The crop-livestock circulation system according to claim 5, wherein the conveying unit comprises a transport pipe and a self-priming centrifugal jet pump mounted on the transport pipe;
a first end of the transport pipe is connected to the fertilizer storage tank, and a second end of the transport pipe is connected to the spraying device; and
the transport pipe is provided with a stop valve.

7. The crop-livestock circulation system according to claim 6, wherein the spraying device comprises two slide rails and a transverse frame; the two slide rails are provided on two inner sides of the planting greenhouse, respectively; and the transverse frame is slidably provided between the two slide rails;
the transverse frame is provided with a water spray pipe; and
a plurality of nozzles are arranged evenly spaced apart on the water spray pipe.

8. The crop-livestock circulation system according to claim 7, wherein the water spray pipe is communicated with a first end of a water filter pipe;
a second end of the water filter pipe has two branches, and the two branches are communicated with a water source and the transport pipe, respectively;
a filter screen is provided inside the first end of the water filter pipe;
the water filter pipe is connected to an underground pipe; and
the underground pipe is located on the water filter pipe at a side of the filter screen away from the water spray pipe.
